(19) United States
(12) Patent Application Publication
(10) Pub. No.: US 2010/0311334 A1
(43) Pub. Date: Dec. 9, 2010

(54) Integrated Signal Receiver

(75) Inventor: James Digby Yarlet Collier, Suffolk (GB)

Correspondence Address: Novak Druce DeLuca + Quigg LLP (CSR), 300 New Jersey Avenue, NW, Fifth Floor, Washington, DC, 20001, US

(73) Assignee: CAMBRIDGE SILICON RADIO LIMITED, Cambridge (GB)

(21) Appl. No.: 12/865,117

(22) PCT Filed: Jan. 2, 2009
(86) PCT No.: PCT/EP2009/050007

§ 371 Date: Aug. 12, 2010

(30) Foreign Application Priority Data
Jan. 28, 2008 (GB) 0801523.2

(51) Int. Cl. H04W 88/02

(52) U.S. Cl. 455/41.2; 455/150.1; 455/73; 455/255

(57) ABSTRACT

A signal receiver having: an input for receiving radio signals; a clock; a receiving section for processing signals received at the input, the receiving section being configured to operate in: (a) a first mode for processing the received signals in accordance with a first protocol and in dependence on the state of the clock, and (b) a second mode for processing the received signal in accordance with a second protocol by steps including storing a sample of data received in accordance with the second protocol together with a representation of the state of the clock when that data was received, and subsequently comparing a timing indicated by the content of the stored sample of data with the timing indicated by the stored state of the clock.

This invention relates to signal receivers for receiving signals such as radio signals.

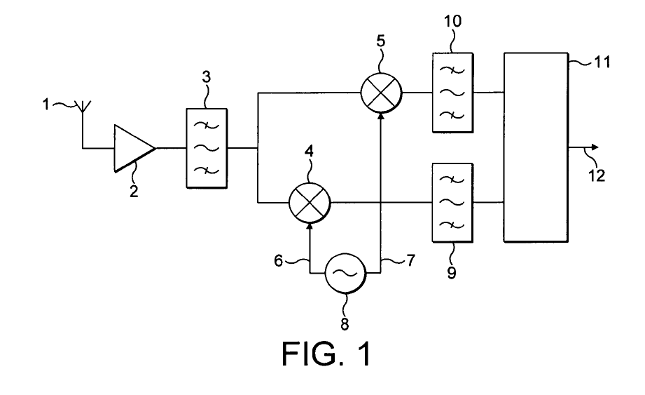

FIG. 1 is a simplified diagram of one form of radio receiver. Signals received at the antenna 1 are amplified by amplifier 2 and then filtered by input filter 3 to attenuate signals outside the band in which the wanted signals lie. Typically, the input filter 3 will be sufficiently wide to pass all the channels of the band that is to be received. The output of the filter 3 is downconverted by mixing in mixers 4, 5 with in-phase (I) and quadrature (Q) local oscillator signals at 6, 7 to form I and Q signals at the outputs of the mixers. The local oscillator signals are generated by a local oscillator 8 at such a frequency that the mixing operation shifts the channel that is desired to be received into a desired frequency range. The outputs of the mixers are filtered by I and Q filters 9, 10 to attenuate components outside the desired frequency range, and the outputs of the I and Q filters are supplied to a baseband processing section 11. The baseband processing section processes the received signals to recover traffic data from them. As is well-known, it uses the availability of I and Q signals to distinguish between image frequencies and form a representation of the signal received at a particular frequency, and then identifies the data symbols represented by that signal. The data symbols represent traffic data and the recovered traffic data is output at 12. The processing performed by the baseband processing section 11 will typically be done in the digital domain.

The receiver illustrated in FIG. 1 includes a single mixing stage. Receivers may alternatively include two or more mixing stages. Receivers may include more or fewer amplification and/or filtering stages.

When designing a receiver to receive signals of a particular protocol, various components of the receiver need to be configured to match the set of channels that are used by that protocol. For example, the Bluetooth protocol uses 79 channels whose centres are spaced apart by 1 MHz in the range from 2.402 GHz to 2.480 GHz. To configure a receiver for receiving Bluetooth signals the input filter 3 is typically set to pass signals from around 2.4 to 2.5 GHz, the local oscillator 8 is arranged to be capable of adopting a desired one of a set of frequencies spaced apart by the channel spacing of 1 MHz, and the I and Q filters 9, 10 are set to have passbands that accommodate essentially a single Bluetooth channel and occupy the band to which the local oscillator frequencies translate respective desired channels. In addition, the baseband section is configured for decoding Bluetooth signals.

Normally, at least some of the hardware used in the receiver is dedicated for use in accordance with the protocol for which the receiver is designed. In comparison with hardware that is adjustable in use, such dedicated hardware typically has the advantages that it can be formed more economically, uses less circuit area, and typically consumes less power. This is particularly the case with filters, which are normally not widely adjustable. The requirements of reduced area and power reduction are especially significant in the case of receivers that are formed on a single integrated circuit (IC).

An example of another protocol is GPS (Global Positioning System). In the GPS protocol coarse/acquisition (C/A) signals are conveyed with a bandwidth of 2.046 MHz on a channel known as the L1 channel.

There is an increasing tendency for equipment such as end-user devices to be capable of communicating using multiple protocols. For example, it may be desirable for a device such as a mobile phone to be capable of using (i) a mobile telecoms protocol such as GSM or 3G for communicating with a mobile phone network, (ii) a short-range radio protocol such as Bluetooth or 802:11 for passing data to nearby devices such as printers, and (iii) a satellite location protocol such as GPS or, when available, Galileo. In order to achieve this, receivers for all of these protocols must be installed in the device. One way for that to be done is by installing in the device individual receiver circuits for each protocol. Those circuits could be embodied by discrete components or incorporated on to an integrated circuit which could be included in the device.

Where two bands have closely similar channel characteristics it is possible to receive them using a single receiver. However, there are some situations where this is generally viewed as undesirable. When a receiver is capable of receiving two bands it can generally be used for receiving only one of those bands at any one time. If the characteristics of the two bands are such that reception on them cannot readily be interleaved then it is preferred to use two separate receivers for those bands. One situation in which this is the case is when one of the protocols requires ongoing reception of signals that are broadcast to multiple devices without the possibility of any receiving device requesting retransmission of data that it receives incorrectly, because in that case interruption to such reception must generally be minimised. An example of such a protocol is GPS. Another example of such a situation is where one of the protocols may be used intermittently for transmitting data to the receiver as it becomes available to the transmitting device. In that case, the receiver may miss transmitted data if it is in use for another protocol at the time the data is sent. An example of such a protocol is Bluetooth. Although the duty cycle for Bluetooth is typically around ⅓, leaving around ⅔ of the time for reception of other signals, there are situations where the duty cycle is higher or where the timings of Bluetooth signals cause problems for reception of signals on another protocol.

WO 02/14889 describes a combined Bluetooth and GPS receiver. This receiver has various complications that make it problematic to implement in practice. One is that the filters of the receive chain are adjusted depending on the mode in which it is receiving. Another is that the mechanism used to generate local oscillator signals for both Bluetooth and GPS is complex. Another is that different configurations are used to digitise GPS and Bluetooth signals (see FIGS. 3B and 3C of WO 02/14889).

It would be desirable to further reduce PCB and/or silicon real-estate and/or reduce power consumption in devices that include multiple receivers. Embodiments of the present invention may but do not necessarily address those problems and can address other problems, some of which will be identified below.

According to one aspect of the present invention there is provided a signal receiver having: an input for receiving radio signals; a clock; a receiving section for processing signals received at the input, the receiving section being configured to operate in: (a) a first mode for processing the received signals in accordance with a first protocol and in dependence on the state of the clock, and (b) a second mode for processing the received signal in accordance with a second protocol by steps including storing a sample of data received in accordance with the second protocol together with a representation of the state of the clock when that data was received, and subsequently comparing a timing indicated by the content of the stored sample of data with the timing indicated by the stored state of the clock.

The receiver may be configured to operate in the first mode by attributing received signals to different transmitting stations in dependence on the state of the clock when the signals were received and or the frequency on which the on which the signals were received. It may listen on a specific frequency or range of frequencies at any time in dependence on the state of the clock at that time.

The signal receiver may comprise a transmitter for transmitting signals in accordance with the first protocol, the receiver being configured to transmit signals at times dependent on the state of the clock.

The clock may have an output of a first frequency and the operations in accordance with the first protocol may be dependent on a signal of a second frequency derived by frequency division of the said output.

The first protocol is conveniently a protocol whose channels are in the ISM (industrial, scientific and medical) band. The first protocol may be Bluetooth.

The first clock may have a frequency greater than 100 MHz.

The said step of comparing a timing may include correlating the sample of data with one or more simulated samples of data generated in dependence on the state of the clock as stored together with the stored sample of data and determining an offset between the timing represented by the state of the stored signals as received at the stored time and the state of the clock at that time.

The said step of correlating is preferably performed by means of software.

The signal receiver may comprise a location estimator configured to estimating the location of the receiver in dependence on the result of the said step of comparing.

The second protocol may be a satellite location protocol.

The second protocol may be a satellite location protocol such as GPS (Global Positioning System) or Galileo.

According to a second aspect of the invention there is provided a signal receiver having: an input for receiving radio signals; a local oscillator for forming a local oscillator signal; at least one mixing stage for mixing with the local oscillator signal a received signal from the input; at least one filter for filtering the output of the mixing stage; the receiver being capable of operating in a first mode for receiving signals in the ISM (industrial, scientific and medical) band and in a second mode for receiving signals of a satellite location protocol, and the frequency divider being configured to divide the output of the local oscillator by a first predetermined value when the receiver is operating in the first mode and to divide the output of the local oscillator by a second predetermined value different from the first value when the receiver is operating in the second mode.

The second predetermined value is preferably 3/2 times the first predetermined value. The first predetermined value may conveniently be 2 or 4.

Preferably the frequency divider is configured to divide the output of the local oscillator by the first predetermined value whenever the receiver is operating in the first mode.

The frequency divider may be configured to divide the output of the local oscillator by the second predetermined value whenever the receiver is operating in the second mode.

The first protocol may be a short-range radio protocol. The first protocol may be Bluetooth. The second protocol may be a satellite location protocol such as GPS (Global Positioning System) or Galileo.

The oscillatory circuit conveniently comprises a voltage controlled oscillator.

The signal receiver may comprise a filter for filtering the output of the mixer. The receiver may be such that the passband of the filter remains the same irrespective of whether the receiver is operating in the first or second mode.

The said signals in the ISM band are conveniently channelised signals. The passband of the filter is suitably approximately equal to the width of the channels of those signals: for example between 1 and 2 times the channel width.

The centre of the passband of the filter may conveniently be located at less than 10 MHz.

According to a third aspect of the invention there is provided a signal receiver capable of operating in a first mode for receiving signals in the ISM (industrial, scientific and medical) band and in a second mode for receiving signals of a satellite location protocol, the receiver having a receive chain comprising: an input for receiving radio signals; a local oscillator for forming a local oscillator signal; at least one mixing stage for mixing the local oscillator signal and a signal from the input; at least one filter for filtering the output of the mixing stage; at least one analogue-to-digital converter for converting the output of the filter to the digital domain; and a decoder for decoding the output of the or each analogue-to-digital converter to extract traffic data therefrom, the decoder being capable of decoding signals in the ISM (industrial, scientific and medical) band when the receiver is operating in the first mode and decoding signals of the satellite location protocol when the receiver is operating in the second mode; and the receiver being arranged such that the filter(s) and/or the analogue-to-digital converter(s) is/are unchanged irrespective of whether the receiver is operating in the first or second mode.

The signal receiver may comprise one or more further filters located between the input and the mixing stage for filtering a signal received by the input to form the said signal from the input.

The receiver may be arranged such that the further filter(s) and the analogue-to-digital converter(s) are unchanged irrespective of whether the receiver is operating in the first or second mode.

The signal receiver may comprise only a single mixing stage between the input and the analogue-to-digital converter.

The said signals in the ISM (industrial, scientific and medical) band are conveniently Bluetooth signals.

The said satellite location protocol may be GPS (Global Positioning System) or Galileo.

The signal receiver may be implemented on a single integrated circuit.

The present invention will now be described by way of example with reference to the accompanying drawings.

In the drawings:

FIG. 1 is a schematic drawing of a receiver design;

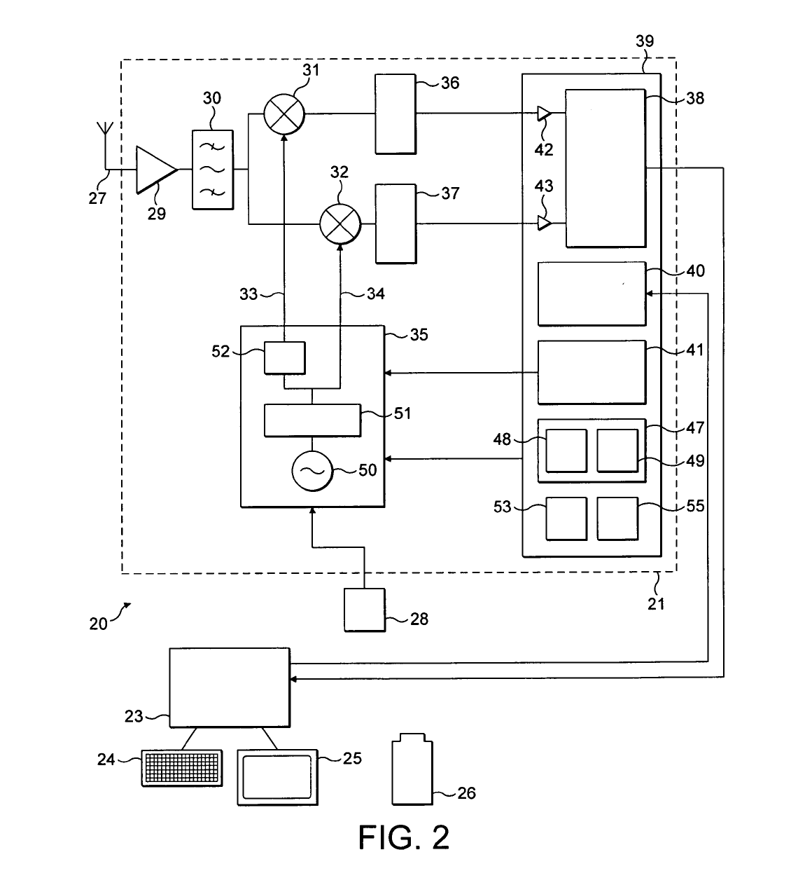

FIG. 2 is a schematic drawing of a device including a receiver on an integrated circuit.

The device 20 of FIG. 2 has a multi-band receiver IC 21 that is capable of receiving Bluetooth and GSM signals through a single receive chain indicated generally at 22.

The device 20 of FIG. 2 comprises a main device controller 23, the multi-band receiver IC 21, a user interface input device 24, such as a keypad, and a user interface output device 25, such as a display. The device also has a battery 26 for powering the other components, an antenna 27 which provides a radio frequency (RF) feed to the receiver IC and a crystal 28 which provides a timing reference for the receiver IC. These components are exemplary, and the components that are provided in practice will depend on the intended purpose of the device. For instance, instead of a battery, other means of power supply such as mains power or a fuel cell could be used. The antenna could be integrated with the IC 21. The crystal could be omitted if the other timing facilities of the device or the IC are adequate. The device could, for example, be a cellular telephone or a PND (personal navigation device).

The receive chain 22 of the IC comprises an amplifier 29 which amplifies signals received from the antenna 27. The output of the amplifier is then filtered by input filter 30 to attenuate signals outside the band from which signals are to be received. Typically, the input filter 30 will be sufficiently wide to pass all the channels that might be received in accordance with the bands that are in use, as it is preferred that the bandwidth of the filter 30 is not altered when the receiver switches between receiving signals of different protocols. The output of the filter 30 is downconverted by mixing in mixers 31, 32 with in-phase (I) and quadrature (Q) local oscillator signals from lines 33, 34 to form I and Q signals at the outputs of the mixers. The local oscillator signals are generated by a local oscillator 35 at such a frequency that the mixing step shifts the channel that is desired to be received into a desired frequency band, centred on a predetermined intermediate frequency. The outputs of the mixers are filtered by I and Q filters 36, 37 to remove components outside the desired frequency band, and the outputs of the I and Q filters are supplied to a decoder 38. The decoder 38 is part of a digital processing section 39 of the IC 21.

The digital processing section 39 includes the digital decoder 38, a digital encoder 40 and a control section 41. In the digital processing section the I and Q signals from the filters 36 and 37 are digitised by analogue-to-digital converters 42, 43 and then passed to the decoder 38. The decoder processes the received signals to recover traffic data from them. It uses the availability of I and Q signals to distinguish image frequencies and then recovers received symbols from the desired signal frequency. The symbols represent traffic data and the recovered traffic data can be passed via line 44 to the device controller 23. The device controller 23 can then process that data, for example by displaying it on the display 24.

The encoder 40 can encode data passed to it by the device controller 23 over line 45 and cause it to be transmitted via a transmit chain (not shown) over antenna 27.

In this example embodiment the multi-band receiver IC 21 is capable of receiving both Bluetooth and GPS signals. This involves the reception of signals from two frequency bands and of two protocols. This combination is an example. The IC could be capable of receiving on more than two bands, or receiving on other bands than Bluetooth and GPS. The manner in which it receives on multiple bands using a single set of receiver hardware will be described below.

The control section 41 operates under the control of the device controller 23 to cause the IC to operate in a desired receive mode, i.e. to receive Bluetooth or GPS signals. The control section 41 configures the other components of the IC to operate in accordance with whichever mode (Bluetooth or GPS) the receiver is to operate in. The manner in which it does so will be described in more detail below.

The decoder 38 is a digital signal processor (DSP) which operates in accordance with program code stored in a non-volatile memory 47. The code includes instructions 48 for performing Bluetooth decoding, and instructions 49 for performing GPS decoding. The mode selection unit causes the decoder 38 to use the set of instructions that is appropriate to the signals that are to be received. When the receiver is to receive Bluetooth signals the decoder executes the instructions 48. When the receiver is to receive GPS signals the decoder executes the instructions 49.

The local oscillator 35 comprises an oscillator unit 50. This will typically be implemented as a voltage-controlled oscillator (VCO). The frequency of the oscillator is controlled by logic of the DSP so that the oscillator generates signals of a frequency suitable for mixing the desired channel in the received signal down to the desired intermediate frequency. The frequency can be controlled with reference to a signal received from the crystal 28.

The output of the VCO passes to a frequency divider 51. This divides the frequency of the output signal of the VCO by one of a number of set values, each set value corresponding to one of the bands on which the receiver is to receive. By using one of a number of available divisors in this way the VCO can be kept within a relatively narrow frequency range whichever band the receiver is operating on. In the case of a receiver for Bluetooth and GPS the divider can conveniently divide by either 4 (for Bluetooth use) or 6 (for GPS use). This allows the VCO to be operated in the region of 9.5 GHz for reception of both sets of signals. In general, appropriate values can be chosen to achieve a satisfactory compromise between the range over which the VCO needs to be adjusted and the frequency at which the VCO needs to operate, which is preferably not too high. The divider adopts the appropriate mode in response to signalling from the control section 41.

Assuming for illustration an IF of zero Hertz, in order to yield suitable local oscillator frequencies for use with Bluetooth when divided by 4 the VCO would operate in the range from around 9.45 to 9.92 GHz. That represents a fractional range of around 5%. To yield a suitable VCO signal for use with GPS the local oscillator would then operate at around 9.45 GHz.

The local oscillator 35 also comprises a 90° phase shift unit 52 whereby the phase offset of the I and Q signals is formed. The phase shifting may be accomplished by dividing the output of the VCO by two when forming both I and Q signals, the division being triggered in one case on a rising edge and in the other case on a falling edge.

In practice, the receiver may be required to switch relatively often between modes: potentially several times each second. For this reason the DSP 38 includes a state maintenance block 53 which maintains state associated with both modes, irrespective of which mode is currently in use. The state is stored in volatile memory. One example of such state information is the state of the receiver's local clock. Bluetooth devices are required to maintain an accurate clock for synchronising Bluetooth operations. The local clock of the receiver is shown at 55. Bluetooth clock data is required to have a resolution of 1 μs and must be maintained to an accuracy of 20 ppm Other examples of such state information are Bluetooth security data such as pairing information, Bluetooth power settings and GPS satellite ephemeris.

When operating in its mode for Bluetooth reception the control unit 41 signals the decoder 42 to execute the instructions 48 to decode Bluetooth signals and signals the local oscillator 35 so that its divider 51 operates in divide-by-4 mode. The DSP 38 then controls the frequency of the VCO in accordance with the Bluetooth frequency-hopping pattern so that the I and Q signals are such as to mix the expected receive frequency down to the predetermined intermediate frequency.

When operating in its mode for GPS reception the control unit 41 signals the decoder 38 to execute the instructions 49 to decode GPS signals and signals the local oscillator 35 so that its divider operates in divide-by-6 mode. The DSP then controls the frequency of the VCO so that the I and Q signals are such as to mix the desired GPS receive frequency down to the predetermined intermediate frequency.

The intermediate frequency used for Bluetooth reception is preferably the same as, or substantially the same as, the intermediate frequency used for GPS reception. In that way the filters 36 and 37 can be kept at a constant setting irrespective of which mode the receiver is operating in. This requires that the signals at 33 and 34 be of a frequency such that the centre frequency of any channel being received (irrespective of which protocol the channel is from) is shifted to roughly the same intermediate frequency, with the effect that the channel falls within the passbands of filters 36 and 37.

In this way a single receiver chain can be used to receive both Bluetooth and GPS signals. The same analogue-to-digital converters 42 and 43 are used in each mode, and the local oscillator can be implemented conveniently by means of an oscillator that is finely adjustable (e.g. a VCO) whose output is frequency divided by divisors appropriate to each reception band. The divisors are conveniently whole numbers. The divisor could be unity for one of the bands. Instead of reducing the frequency, the frequency multiplication by appropriate factors (mathematically equivalent to frequency division by a divisor less than one) could be used. However, this is less preferred as it may be expected to introduce more errors.

The filters 36 and 37 are set to pass a bandwidth of around 2 MHz. This is performs a significant degree of channel selection for Bluetooth. All of the wanted signal Bluetooth signal will pass the filters and the limited amount of signal from adjacent channels that passes the filters can be removed by subsequent filtering, conveniently in the digital domain. A 2 MHz filter bandwidth is well suited to GPS reception.

In order to determine its position using GPS the receiver needs to determine the relative timings of C/A (coarse/acquisition) signals received from multiple satellites. This can be done by determining the offsets between a clock in the receiver and the timings of signals received from each satellite. To determine such an offset for an individual satellite's signals the receiver can receive signals from that satellite and perform a correlation operation to determine the best match between the received signals and simulated received signals generated at the receiver with different time delays or advances. This correlation operation can be performed by parallel processing on the received signal as it arrives. Another option is to perform the correlation operation in software, for example as is described in WO 04/03623. In the latter route, the received CIA signals could be stored in memory for subsequent correlation processing to determine the time offset. However, if this is done then the precise time at which those C/A signals were received must be recorded in order that the appropriate simulated receive signals can be generated. In the receiver of FIG. 2, the received C/A signals are time stamped with the time at which they were received as indicated by the receiver's local clock 55. This is convenient because the local clock of the receiver is implemented on the IC 22 and is required to be highly accurate in order for the Bluetooth protocol to be operated correctly. Although the Bluetooth clock data is not needed to have an especially high resolution, in practice that data is typically derived by division from a clock that runs at a much higher frequency in order to achieve the accuracy that is required. Hence the local clock of the receiver can be expected to provide a higher level of precision than is required of Bluetooth clock data.

Thus, in order to estimate the timing of GPS signals the receiver receives and stores samples of received GPS data. Each sample comprises a set of contiguously received GPS data. Each sample or block of samples is stored in conjunction with a value derived from the receiver's local clock that is used to provide the Bluetooth clock data, representing the time according to the local clock of the receiver at which the some predetermined feature of the sample occurred, such as the start of the sample. The sample is subsequently processed to correlate the timing of the data contained in the signal relative to the local clock of the receiver. Once this has been done for the data from numerous satellites the device can determine its location as normal. To allow the location of the receiver to be determined with adequate precision it is preferred that the frequency of the clock is greater than 10 MHz. It may be that the receiver becomes free for sampling the GPS data at a moment between clock signal timing edges. Nevertheless, the precise timing of the samples should be stored. One way in which this may be done is to initially refrain from storing samples and then store those samples received starting from the moment of the next clock signal timing edge. Another way is to count the number of samples that are taken and stored until the moment of the next clock signal timing edge, and to store that number together with the samples for use as an offset in the correlation operation.

The antenna 27 could be a compound antenna that is adapted to facilitate reception on each band on which the receiver operates. Alternatively, the receive chain could be split so that at least the frontmost end of the receive chain can be specific for each band that is to be received. One option is to have two antennas and two LNAs, each having its input connected to the output of a respective one of the antennas, and to combine the outputs from the LNAs upstream of the mixers. Another option is to have two antennas, two LNAs arranged as above and two sets of mixers, each set having its inputs connected to the output of a respective one of the LNAs. In that way the antenna, the LNA and optionally the mixers can be customised for a respective one of the bands. Preferably the same filters are used in each mode, and most preferably the same filters are used in each mode at any points where filtering is performed between the mixers (or the final mixers if more than one mixing stage is used) and the stage at which the signals are digitised.

Similar control mechanisms could be used to allow a receiver to be shared between other protocols. For example, a single receiver could operate in this way to receive Bluetooth and Galileo signals, or indeed to receive signals from any combination of two or more bands including but not limited to Bluetooth, GPS, Galileo, GSM, 3G and 802.11. However, it has been found that there are particular synergies in receiving Bluetooth and GPS or Galileo signals through the same receiver because switching between division by 2 or 3 in the local oscillator is convenient and because they can be readily received with filters of the same bandwidth. In other combinations it might be necessary to adjust the bandwidth or centre frequency of any of the filters 29, 36, 37 on switching between receive bands. Galileo signals have a bandwidth of approximately 4 MHz centred on 1.57542 GHz.

It is possible that the device which includes the receiver may have to make use of both bands concurrently. For example, the device might be a GPS locationing device that is intended to determine its position by GPS and frequently report the determined position by Bluetooth to a neighbouring device. A device of that type must be capable of receiving sufficient GPS data that it can determine its position, whilst receiving sufficient Bluetooth data that it can maintain a Bluetooth connection with the neighbouring device. It may also be that due to self-interference the device is incapable of receiving GPS data when it is transmitting Bluetooth data. Another advantage of interleaving Bluetooth and GPS reception is that the same local oscillator can be used for reception (as described above) and for transmission. In that situation the device must interleave three functions: Bluetooth reception, Bluetooth transmission and GPS reception.

In order to address this issue the controller 41 controls the operation of the receiver, and transmitter to decide on which band reception should take place. In normal operation the controller 41 interleaves Bluetooth and GPS reception, devoting as much time as possible to Bluetooth reception subject to the requirement that it maintains track of its position by GPS. It is possible to perform GPS locationing when GPS signals are received discontinuously—for less than 100% of the time—provided that the receiver is still capable of tracking the GPS time clock accurately. Provided the receiver knows accurately when fragments of the GPS signal have been received, those discontinuous fragments can be processed, taking into account their time of reception, in order to recover sufficient of the GPS signal to obtain a locational fix. Depending on the quality of GPS signal reception and the accuracy of the receiving device's internal clock it is possible to perform locationing when less than 20% or even less than 10% of the GPS signal has been received. In normal operation the scheduler makes use of this property by setting the amount of time to be allocated to GPS reception to be less than 100%, but sufficient that locationing can still be performed using the method described above. In some operational situations the scheduler may dedicate reception to a single one of the bands, and no reception takes place on the other band. Examples of such situations are where the user has disabled one of the bands or when, due to an unexpected circumstance, reception on one band is to be prioritised. One specific example is when the device needs to find its location urgently due to an emergency, in which case the receiver could be dedicated for GPS reception until a location has been established. This may be done by reserving a set proportion of the time (e.g. 20%, 30% or 50%) for GPS reception, and allowing Bluetooth reception during the remainder of the time. Alternatively, it may be done by adjusting the proportion of time allocated for GPS reception in dependence on feedback from the baseband section on the quality of GPS data it currently has. If the quality of GPS decoding is low then the amount of time dedicated to GPS reception could be increased, and vice versa. In practice, the amount of time needed for GPS reception may also depend on the quality of the device's onboard clock, which determines how long it can maintain sufficiently precise synchronisation with the GPS signals to allow coherent addition and the quality of GPS reception, which governs how much of the received GPS signals are actually usable.

The device could take any suitable form. Non-limiting examples include locationing devices, mobile phones, vehicles and computers. The device could report data derived from reception of signals of one of the protocols on which it can receive by means of a transmitter that transmits signals of the other of the protocols whose data the device can receive. In the case of a locationing device, the device could derive its location by receiving on one of the protocols and could transmit that location or less processed data such as the IQ samples together with their time stamps, or satellite location time differences (pseudo ranges) using the other of the protocols. The advantage of sending such less processed data (particularly the IQ samples together with their time stamps) to a host is that processing capabilities can be utilized to perform the correlation and other locationing steps without the host needing to have a clock that is sufficiently precise and sufficiently well synchronised to assess the timing of received signals.

Components of the device that are not essential in some embodiments, such as the user interface components, could be omitted.

The receiver could include more than one mixing stage, and more than one local oscillator. Further local oscillators could be adjusted in accordance with the desired receive frequency or, if they are located in the receive chain after the point at which the received signals have been converted to a fixed intermediate frequency, they could remain constant irrespective of which band is being received. The receiver could include further filter stages. These could be adjusted in accordance with the desired receive frequency and/or bandwidth or, if adequate reception of either band is possible if they are not varied, they could remain constant irrespective of which band is being received. The receiver could include further amplification stages or other components. The receiver could be implemented on a single integrated circuit (as shown in FIG. 2), on multiple integrated circuits and/or from discrete components.

The receiver is not limited to receiving Bluetooth and GPS data, but could receive data from other bands instead or in addition. Conveniently it is capable of receiving data from at least one protocol that operates in the ISM band, such as Bluetooth or 802:11 wireless LAN protocols, and from a satellite location protocol. The two protocols are preferably within a similar region of the frequency spectrum: for example by the operating frequencies of one band differing from the operating frequencies of the other band by a factor of less than 10, 5 or most preferably 2. Signals of the two protocols preferably have similar bandwidths: for example within 20% or 50% of each other. The receiver could operate in an analogous way for reception of three or more protocols.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A signal receiver having:
an input for receiving radio signals;
a clock;
a receiving section for processing signals received at the input, the receiving section being configured to operate in: (a) a first mode for processing the received signals in accordance with a first protocol and in dependence on the state of the clock, and (b) a second mode for processing the received signal in accordance with a second protocol by steps including storing a sample of data received in accordance with the second protocol together with a representation of the state of the clock when that data was received, and subsequently comparing a timing indicated by the content of the stored sample of data with the timing indicated by the stored state of the clock.

2. A signal receiver as claimed in claim 1, wherein the receiver is configured to operate in the first mode by attributing received signals to different transmitting stations in dependence on the state of the clock when the signals were received.

3. A signal receiver as claimed in claim 2, further comprising a transmitter for transmitting signals in accordance with the first protocol, the receiver being configured to transmit signals at times dependent on the state of the clock.

4. A signal receiver as claimed in claim 1, wherein the clock has an output of a first frequency and the operations in accordance with the first protocol are dependent on a signal of a second frequency derived by frequency division of the said output.

5. A signal receiver as claimed in claim 1, wherein the first protocol is a protocol whose channels are in the ISM (industrial, scientific and medical) band.

6. A signal receiver as claimed in claim 5, wherein the first protocol is Bluetooth.

7. A signal receiver as claimed in claim 1, wherein the first clock has a frequency greater than 100 MHz.

8. A signal receiver as claimed in claim 1, wherein the said step of comparing a timing includes correlating the sample of data with one or more simulated samples of data generated in dependence on the state of the clock as stored together with the stored sample of data and determining an offset between the timing represented by the state of the stored signals as received at the stored time and the state of the clock at that time.

9. A signal receiver as claimed in claim 1, wherein the said step of correlating is performed by means of software.

10. A signal receiver as claimed in claim 8, comprising a location estimator configured to estimating the location of the receiver in dependence on the result of the said step of comparing.

11. A signal receiver as claimed in claim 1, wherein the second protocol is a satellite location protocol.

12. A signal receiver as claimed in claim 1, wherein the second protocol is GPS (Global Positioning System) or Galileo.

13. A signal receiver having:
an input for receiving radio signals;
a local oscillator for forming a local oscillator signal;
at least one mixing stage for mixing with the local oscillator signal a received signal from the input;
at least one filter for filtering the output of the mixing stage;
the receiver being capable of operating in a first mode for receiving signals in the ISM (industrial, scientific and medical) band and in a second mode for receiving signals of a satellite location protocol, and the frequency divider being configured to divide the output of the local oscillator by a first predetermined value when the receiver is operating in the first mode and to divide the output of the local oscillator by a second predetermined value different from the first value when the receiver is operating in the second mode.

14. A signal receiver as claimed in claim 13, wherein the second predetermined value is 3/2 times the first predetermined value.

15. A signal receiver as claimed in claim 14, wherein the first predetermined value is 4.

16. A signal receiver as claimed in claim 14, wherein the first predetermined value is 2.

17. A signal receiver as clamed in claim 13, wherein the frequency divider is configured to divide the output of the local oscillator by the first predetermined value whenever the receiver is operating in the first mode.

18. A signal receiver as clamed in claim 13, wherein the frequency divider is configured to divide the output of the local oscillator by the second predetermined value whenever the receiver is operating in the second mode.

19. A signal receiver as claimed in claim 13, wherein the first protocol is Bluetooth.

20. A signal receiver as claimed in claim 13, wherein the second protocol is GPS (Global Positioning System) or Galileo.

21. A signal receiver as claimed in claim 13, wherein the oscillatory circuit comprises a voltage controlled oscillator.

22. A signal receiver as claimed in claim 13, comprising a filter for filtering the output of the mixer, and wherein the receiver is such that the passband of the filter remains the same irrespective of whether the receiver is operating in the first or second mode.

23. A signal receiver as claimed in claim 22, wherein the said signals in the ISM band are channelized signals and the passband of the filter is approximately equal to the width of the channels of those signals.

24. A signal receiver as claimed in claim 22 or 23, wherein the center of the passband of the filter is located at less than 10 MHz.

25. A signal receiver capable of operating in a first mode for receiving signals in the ISM (industrial, scientific and medical) band and in a second mode for receiving signals of a satellite location protocol, the receiver having a receive chain comprising:
an input for receiving radio signals;
a local oscillator for forming a local oscillator signal;
at least one mixing stage for mixing the local oscillator signal and a signal from the input;
at least one filter for filtering the output of the mixing stage;
at least one analogue-to-digital converter for converting the output of the filter to the digital domain; and
a decoder for decoding the output of the or each analogue-to-digital converter to extract traffic data therefrom, the decoder being capable of decoding signals in the ISM (industrial, scientific and medical) band when the receiver is operating in the first mode and decoding signals of the satellite location protocol when the receiver is operating in the second mode; and
the receiver being arranged such that the filter(s) and the analog-to-digital converter(s) are unchanged irrespective of whether the receiver is operating in the first or second mode.

26. A signal receiver as claimed in claim 25, comprising one or more further filters located between the input and the mixing stage for filtering a signal received by the input to form the said signal from the input.

27. A signal receiver as claimed in claim 25, wherein the receiver is arranged such that the further filter(s) is/are unchanged irrespective of whether the receiver is operating in the first or second mode.

28. A signal receiver as claimed in claim 25, comprising only a single mixing stage between the input and the analogue-to-digital converter.

29. A signal receiver as claimed in claim 25, wherein the said signals in the ISM (industrial, scientific and medical) band are Bluetooth signals.

30. A signal receiver as claimed in claim 25, wherein the said the satellite location protocol is GPS (Global Positioning System) or Galileo.

31. A signal receiver as claimed in claim 1, which is implemented on a single integrated circuit.

32. A signal receiver as claimed in claim 13, which is implemented on a single integrated circuit.

33. A signal receiver as claimed in claim 25, which is implemented on a single integrated circuit.
